(19) United States
(12) Patent Application Publication
(10) Pub. No.: US 2026/0356646 A1
(43) Pub. Date: Nov. 12, 2026

(54) HANDLING DEVICE FOR HANDLING A CONTAINER IN A CAPPING STATION AND A CAPPING APPARATUS FOR CAPPING CONTAINERS

(71) Applicant: GEA Procomac S.p.A., Sala Baganza (Parma) (IT)

(72) Inventors: Paolo Abelli, Sala Bagnanza (Parma) (IT); Vittorio Bellini, Sala Bagnanza (Parma) (IT); Fabio Callegari, Sala Bagnanza (Parma) (IT); Luigi Casappa, Sala Bagnanza (Parma) (IT); Gianmaria Raboini, Sala Bagnanza (Parma) (IT)

(73) Assignee: GEA Procomac S.p.A., Sala Baganza (Parma) (IT)

(21) Appl. No.: 19/671,776

(22) Filed: May 8, 2026

(30) Foreign Application Priority Data
May 12, 2025 (EP) 25175597.1

(51) Int. Cl. B67B 3/20

(52) U.S. Cl. CPC B67B 3/206; B67B 3/2066

(57) ABSTRACT

A handling device for handling a container in a capping station, the handling device including:
pliers including two gripping arms, each gripping arm having a free end for gripping a neck of the container under an annular protuberance or bague;
a pliers support to which each gripping arm is hinged;
an engaging member including an arcuate element with at least one first group of teeth, the arcuate element delimiting a pocket for receiving the neck of the container so that a lower surface of the bague leans against the teeth of the first group of teeth, the arcuate element being arranged below the gripping arms and the teeth of the first group of teeth being arranged within recesses obtained in the free ends of the gripping arms.

The present invention relates to a handling device for handling a container in a capping station and to a capping apparatus for capping containers.

The invention finds application in a capping process in which screw caps are applied to containers having a neck provided with an annular protuberance or collar which is known in the field with term “bague”.

In order to perform a proper capping, the container needs to be placed in a perfectly vertical position and aligned with the axis of the capping head and cap, and said position has to be maintained during the whole capping step. At the state of the art, capping stations are thus equipped with devices for gripping and centering containers, which guarantee proper positioning of the containers, correct alignment with the capping head and also prevent rotation of the containers caused by the rotational movement of the capping head.

Document WO 2021/260548 A1 discloses a handling device for containers in a capping and/or inspection station of a capping installation.

The device includes a centering member having a side opening arranged to receive a neck region of a container, and a clamp gripping assembly for holding the container during the capping operations.

The centering member consists of a plate element having a side opening for receiving the neck region of a container so that the collar rests on the upper face of the centering member. In addition, the centering member is provided with teeth intended to engage the lower portion of the collar so as to hold the container and prevent it from rotating under the action of the screwing torque applied to the cap.

The centering member is stationarily mounted, for example screwed, to a centering member-holding plate attached in turn to a centering member-holding flange of the capping unit.

On the other side, the clamp gripping assembly is mounted below and distanced from the centering member and is vertically slidable between a first position, in which it is disengaged from the container and enables removing a capped container and receiving a new container to be capped, and a second position in which it engages the container during the capping operations.

The solution disclosed in WO 2021/260548 A1 still have some criticalities. In particular, it requires containers with a relatively long neck to arrange the clamp gripping assembly and the centering member at a predefined distance.

There is felt the need to further simply the structure of the handling device for handling the containers during capping operations.

In this context, the technical task at the basis of the present invention is to propose a handling device for handling a container in a capping station and a capping apparatus for capping containers, which overcome the problems of the prior art cited above.

In particular, the object of the present invention is to provide a handling device for handling a container in a capping station, which is structurally simpler and more compact with respect to prior art solutions.

Another object of the present invention is to provide a handling device for handling a container in a capping station and a capping apparatus for capping containers, which may be used for any formats of containers having a same neck without changeover of container handling parts.

Another object of the present invention is to provide a handling device for handling a container in a capping station, in which the need of orienting the containers having a square cross-section body is avoided.

The stated technical task and specified aims are substantially achieved by a handling device for handling a container in a capping station, the container having a neck with an annular protuberance or bague, said handling device comprising:
pliers comprising two gripping arms, each gripping arm having a free end, the free ends of the gripping arms being shaped so as to mutually cooperate in gripping the neck of the container under the bague;
a pliers support for supporting the pliers, each gripping arm being hinged to the pliers support;
an engaging member comprising an arcuate element with at least one first group of teeth protruding from the arcuate element.

The arcuate element delimits a pocket for receiving the neck of the container. The arcuate element is arranged below the gripping arms and the teeth of the first group of teeth are arranged within passages or recesses obtained in the free ends of the gripping arms.

According to one aspect of the invention, in the free end of each gripping arm is obtained at least one recess configured to receive at least one tooth of the first group of teeth.

According to one aspect of the invention, the arcuate element comprises at least one additional tooth protruding from the arcuate element. The additional tooth is arranged within a gap obtained between the gripping arms.

Preferably, the teeth of the first group of teeth and the at least one additional tooth are distributed along the arcuate element so as to surround the pocket. More preferably, the additional tooth and the teeth of the first group of teeth are uniformly distributed along the arcuate element.

Preferably, the least one additional tooth is identical to the teeth of the first group of teeth.

According to one aspect of the invention, the gripping arms are rotatable with respect to the pliers support at least between:
a closed configuration, in which the free ends of the gripping arms are brought close in order to grip the container under the bague, and
an open configuration, in which the free ends of the gripping arms are moved away to each other in order to release the container or to receive a new container.

According to one embodiment of the invention, the teeth of the first group of teeth are higher than the recesses. The engaging member is configurable at least in a first configuration in which the teeth of the first group of teeth are in contact with the lower surface of the bague of the container, and in a second configuration in which the teeth of the second group of teeth enter the bague from the lower surface.

According to another embodiment of the invention, the teeth of the first group of teeth are shorter than the recesses. The engaging member is configurable at least in a first configuration in which the teeth of the first group of teeth do not contact the bague of the container, and in a second configuration in which the teeth of the first group of teeth enter the bague from a lower surface of the bague.

Preferably, the gripping arms are hinged to the pliers support at two distinct hinge axes.

Preferably, the handling device further comprises a holding member to which the engaging member is fixedly mounted.

The stated technical task and specified aims are substantially achieved by a capping apparatus for capping containers, the capping apparatus comprising a rotating carousel and a plurality of capping stations arranged on the rotating carousel, each capping station in turn comprising:
a capping head configurable at least in a resting position in which the capping head is distanced from a mouth of a container arranged in the corresponding capping station, and a working position in which the capping head presses a concave closure onto the mouth of the container arranged in the corresponding capping station;
a handling device according to the present invention, said handling device being integrally mounted on the rotating carousel.

According to one embodiment of the invention, the pliers and the pliers support of each handling device are swivelly mounted on the rotating carousel so as to assume at least an upper position and a lower position. The pliers are forced to pass from the upper position to the lower position in response to the capping head assuming the working position.

According to another embodiment of the invention, the pliers and the pliers support of each handling device are fixedly mounted on the rotating carousel.

Further characteristics and advantages of the present invention will more fully emerge from the non-limiting description of a preferred but not exclusive embodiment of a handling device for handling a container in a capping station and a capping apparatus for capping containers, as illustrated in the accompanying drawings, in which:

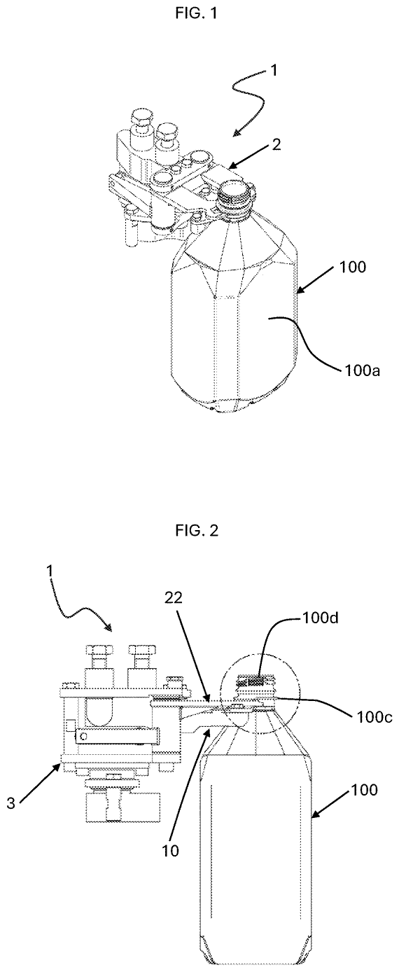

FIG. 1 illustrates a perspective view of a handling device for handling a container in a capping station, according to the present invention;

FIG. 2 illustrates a lateral view of the handling device according to a first embodiment of the invention, with the bague resting on the gripping arms;

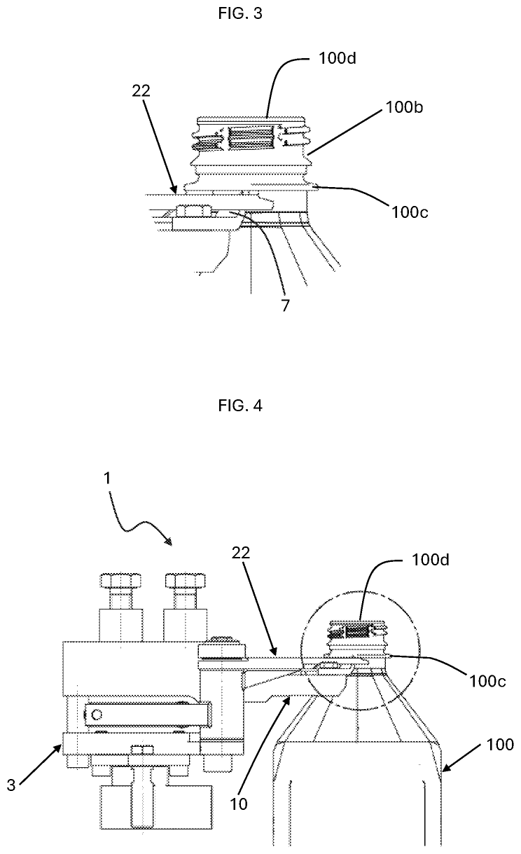

FIG. 3 illustrates an enlarged view of the circled part of FIG. 2;

FIG. 4 illustrates a lateral view of the handling device according to a first embodiment of the invention, with the teeth in engagement with the bague;

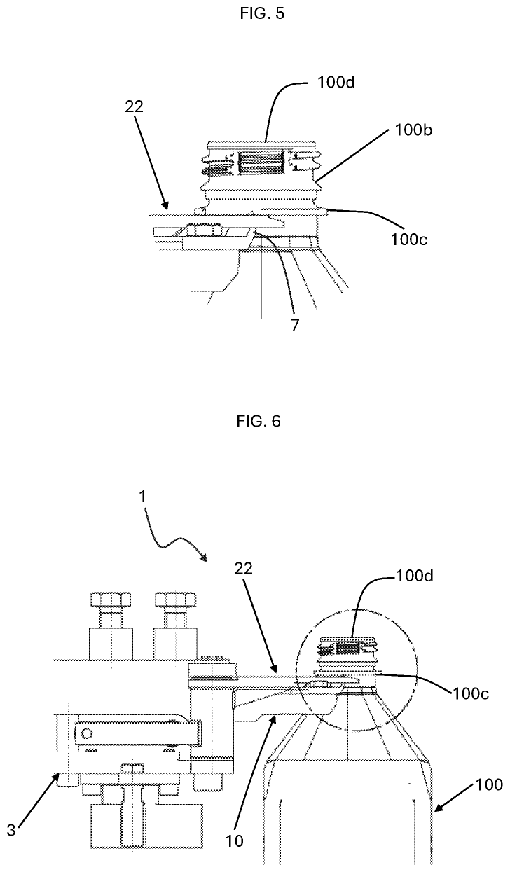

FIG. 5 illustrates an enlarged view of the circled part of FIG. 4;

FIG. 6 illustrates a lateral view of the handling device according to a second embodiment of the invention, with the teeth resting on the bague;

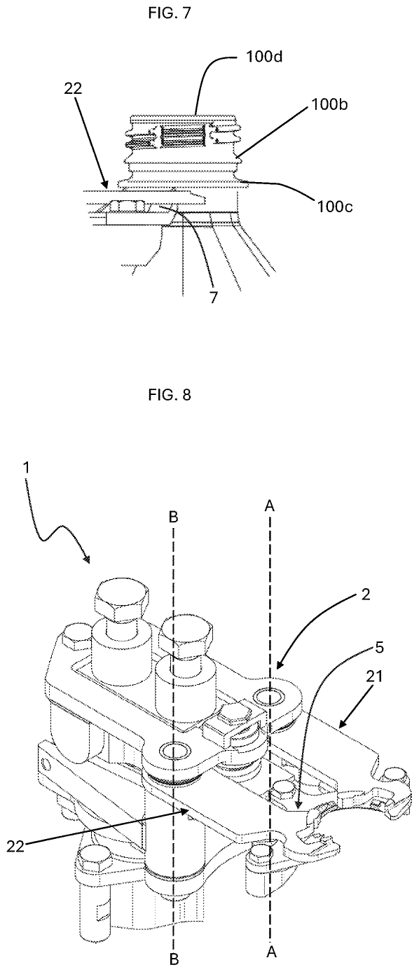

FIG. 7 illustrates an enlarged view of the circled part of FIG. 6;

FIG. 8 illustrates a perspective view of the handling device of FIG. 1, in which the container has been removed;

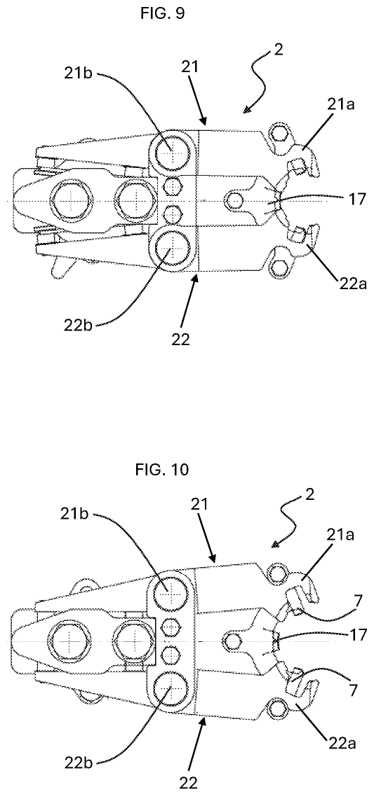

FIGS. 9 and 10 illustrate the handling device of FIG. 8, with the gripping arms respectively in a closed and in open configuration, in a plan view;

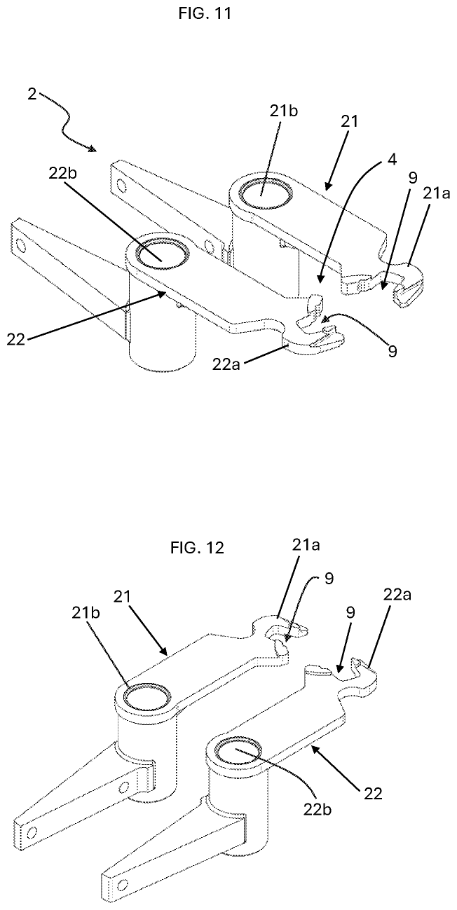

FIGS. 11 and 12 illustrate the pliers of the handling device of FIG. 8, in two different perspective views;

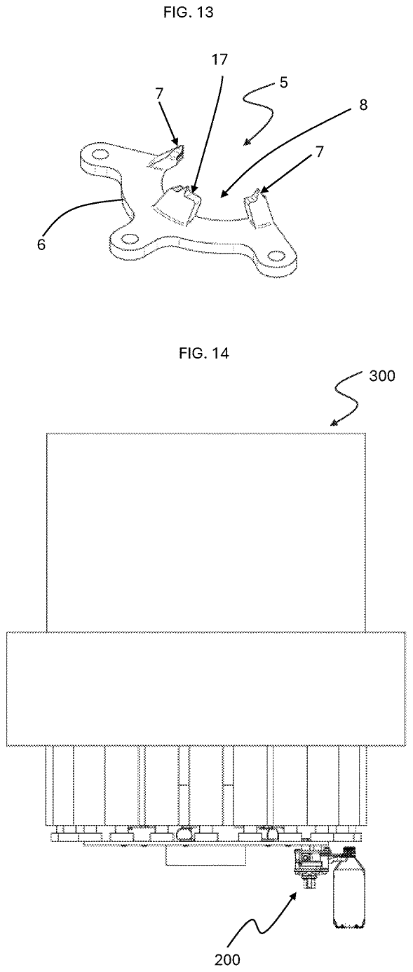

FIG. 13 illustrates a perspective view of the engaging member of the handling device;

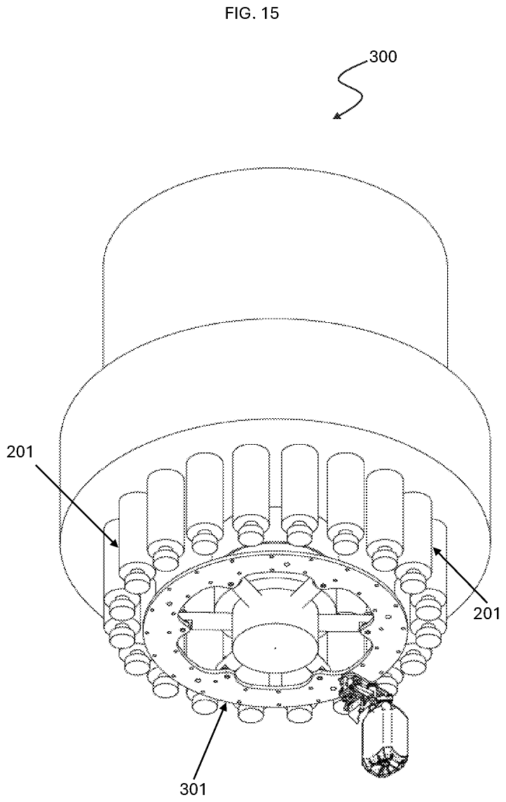

FIGS. 14 and 15 illustrate a capping apparatus for capping containers, according to the present invention, respectively in a lateral and in a perspective view from below.

With reference to the figures, number 1 denotes a handling device for handling a container 100 in a capping station 200.

In this context, the container 100 has a tubular body 100a, a threaded neck 100b with a collar 100c, and a mouth 100d.

In particular, the collar 100c is an annular protuberance which is also referred to as “bague”.

The container 100 may have a discoidal or square or polygonal bottom.

The handling device 1 comprises pliers 2 which are mounted on a pliers support 3.

According to one aspect of the invention, the pliers 2 comprises two gripping arms 21, 22 which are configured to grip the container 100 under the bague 100c. In particular, each gripping arm 21, 22 has a first end 21a, 22a which is a free end, and a fulcrum 21b, 22b which is hinged to the pliers support 3.

In one embodiment of the invention, illustrated herewith, the fulcrums 21b, 22b of the gripping arms 21, 22 are hinged to the pliers support 3 at two distinct hinge axes A-A, B-B.

In another embodiment of the invention, not shown, the fulcrums 21b, 22b of the gripping arms 21, 22 are hinged at a common hinge axis.

The free ends 21a, 22a of the gripping arms 21, 22 are shaped so as to mutually cooperate in gripping the neck 100b of the container 100 under the bague 100c.

In particular, each free end 21a, 22a has a partially arcuate development so as to encircle the neck 100b of the container 100 under the bague 100c.

The gripping arms 21, 22 may be rotated about the hinge axes A-A, B-B (or about the common axis) so as to assume at least two configurations, which are:
a closed configuration, in which the free ends 21a, 22a of the gripping arms 21, 22 are brought close in order to grip the container 100 under the bague 100c, and
an open configuration, in which the free ends 21a, 22a of the gripping arms 21, 22 are moved away to each other in order to release the capped container 100 or to receive a new container 100 to be capped.

The pliers 2 further comprises reactivating means (not shown) which are operatively active on the gripping arms 21, 22 to bring them from the closed to the open configuration.

For example, the reactivating means are of the elastic or magnetic type. According to one aspect of the invention, the gripping arms 21, 22 are arranged so as to create a gap 4 therebetween.

The handling device 1 further comprises an engaging member 5 comprising an arcuate element 6 with at least one first group of teeth 7 protruding from the arcuate element 6.

The arcuate element 6 delimits a pocket 8 for receiving the neck 100b of the container 100. In particular, when the neck 100b of the container 100 is in the pocket 8, the bague 100c may rest on the teeth 7 of the first group of teeth 7.

According to one aspect of the invention, the arcuate element 6 is arranged below the gripping arms 21, 22.

Advantageously, the teeth 7 of the first group of teeth 7 are arranged within passages or recesses 9 obtained in the free ends 21a, 22a of the gripping arms 21, 22.

In this context, the term “recess” indicates an indentation obtained in the free end 21a, 22a of the corresponding gripping arm 21, 22.

According to one embodiment, each free end 21a, 22a of the gripping arms 21, 22 comprises at least one recess 9 configured to receive at least one tooth 7 of the first group of teeth 7.

In the figures provided here, each free end 21a, 22a has one recess 9 only within which is arranged only one tooth 7 of the first group of teeth 7.

In particular, the recess 9 is obtained in an inner region of the corresponding free end 21a, 22a.

In a variant embodiment, more teeth 7 of the first group of teeth 7 may fit within the same recess 9.

According to one embodiment, illustrated herewith, the arcuate element 6 comprises at least one additional tooth 17 protruding from the arcuate element 6.

The additional tooth 17 fits within the gap 4 delimited by the gripping arms 21, 22.

In the figures provided here, only one additional tooth 17 is shown, which is arranged within the gap 4.

In a variant embodiment, more additional teeth 17 are arranged within the gap 4.

Preferably, the additional teeth 17 are identical to the teeth 7 of the first group of teeth 7. In particular, they have the same dimensions.

Preferably, the teeth 7 of the first group of teeth 7 and the additional tooth 17 are distributed along the arcuate element 6 so as to surround the pocket 8.

Preferably, all the teeth (being of the first group of teeth 7 and the additional teeth 17) are uniformly distributed along the arcuate element 6.

The overall number of teeth 7 of the first group of teeth 7 and the additional teeth 17 may vary depending on the needs.

The handling device 1 further comprises a holding member 10 to which the engaging member 5 is fixedly mounted.

In a first embodiment of the invention, the teeth 7 of the first group of teeth 7 are shorter than the recesses 9 so that said teeth 7 do not protrude from the free ends 21a, 22a of the gripping arms 21, 22.

In this first embodiment of the invention, the additional teeth 17 are shorter than the gap 4 so that the additional teeth 17 do not protrude from the gripping arms 21, 22.

According to this first embodiment of the invention, the engaging member 5 is configurable at least in:
a first configuration in which the teeth 7 of the first group of teeth 7 do not contact the bague 100c of the container 100, and
a second configuration in which the teeth 7 of the first group of teeth 7 engage with the lower surface of the bague 100c.

FIGS. 2 and 3 show the first configuration of the engaging member 5 in the first embodiment, whereas FIGS. 4 and 5 show the second configuration of the engaging member 5 in the first embodiment.

In particular, in the second configuration the teeth 7 of the first group of teeth 7 enter, i.e., penetrate, the bague 100c from the lower surface.

In this first embodiment of the invention, when the engaging member 5 is in the first configuration, the at least one additional tooth 17 is also not in contact with the bague 100c of the container 100.

In this first embodiment of the invention, when the engaging member 5 is in the second configuration, the at least one additional tooth 17 is also configured to penetrate in the bague 100c from the lower surface.

In a second embodiment of the invention, the teeth 7 of the first group of teeth 7 are higher than the recesses 9 so that said teeth 7 protrude from the free ends 21a, 22a of the gripping arms 21, 22.

In this second embodiment of the invention, the additional teeth 17 are higher than the gap 4 so that the additional teeth 17 protrude from the gripping arms 21, 22.

This is shown in FIG. 7.

According to this second embodiment of the invention, the engaging member 5 is configurable at least in:
a first configuration in which the teeth 7 of the first group of teeth 7 are in contact with the lower surface of the bague 100c of the container 100, and
a second configuration in which the teeth 7 of the first group of teeth 7 engage with the lower surface of the bague 100c.

In particular, in the second configuration the teeth 7 of the first group of teeth 7 enter, i.e., penetrate, the bague 100c from the lower surface. This is similar to what already disclosed for the second configuration of the first embodiment.

Preferably, in the second embodiment of the invention, when the engaging member 5 is in the first configuration, the at least one additional tooth 17 is also in contact with the lower surface of the bague 100c of the container 100. This is shown in FIGS. 6 and 7.

Preferably, in this embodiment of the invention, when the engaging member 5 is in the second configuration, the at least one additional tooth 17 is also configured to penetrate in the bague 100c from the lower surface.

Reference number 300 indicates a capping apparatus for capping containers 100.

In one embodiment, the capping apparatus 300 is of the rotating type.

In particular, the capping apparatus 300 comprises a rotating carousel 301 and a plurality of capping stations 200 arranged on the rotating carousel 301.

In particular, each capping station 200 comprises a capping head 201 and a handling device 1 according to the present invention.

The capping head 201 is configurable at least in:
a resting position in which the capping head 201 is distanced from a mouth 100d of a container 100 arranged in the corresponding capping station 200, and
a working position in which the capping head 201 presses a concave closure onto the mouth 100d of the container 100 arranged in the corresponding capping station 200.

In this context, by concave closure is meant a cap or a capsule to be applied to the mouth 100d of the container 100.

Each handling device 1 is integrally mounted on the rotating carousel 301. In particular, the holding member 10 of each handling device 1 is fixedly mounted on the rotating carousel 301.

This means that the engaging member 5 assumes a fixed position with respect to the rotating carousel 301.

On the other side, the pliers support 3 of each handling device 1 can be mounted on the rotating carousel 301 either swiveling or fixedly.

In the first embodiment of the invention, the pliers support 3 (and thus the pliers 2) are movable between at least an upper position and a lower position with respect to the rotating carousel 301.

Preferably, in the first embodiment of the invention, the pliers support 3 (and thus the pliers 2) are swivelly mounted on the rotating carousel 301 so that the pliers 2 can assume at least an upper position and a lower position with respect to the rotating carousel 301. The pliers 2 are forced to pass from the upper position to the lower position in response to the capping head 201 passing from the resting position to the working position.

In a variant of the first embodiment of the invention, the pliers support 3 (and thus the pliers 2) are vertically movable between the upper position and the lower position with respect to the rotating carousel 301. Preferably, the vertical movement is obtained by sliding the pliers support 3 in a substantially vertical direction.

In particular, a process for capping a container 100 using the capping apparatus 300 is disclosed hereafter, with focus on a single capping station 200.

A container 100 to be capped is fed to the capping station 200.

The pliers 2 are initially in the upper position with the gripping arms 21, 22 initially in the open configuration in such a way that the container 100 can be inserted in the capping station 200.

Once the container 100 has been inserted in the capping station 200, the gripping arms 21, 22 pass to the closed configuration so as to grip the container 100 under the bague 100c.

The bague 100c of the container 100 rest on an upper surface of the gripping arms 21, 22.

Initially, the capping head 201 is in the resting position, which means the capping head 201 is distanced from the mouth 100d of the container 100. The capping head 201 holds a concave closure.

Upon the capping head 201 descends on the mouth 100d of the container 100, passing from the resting position to the working position, the container 100 is pushed down.

Consequently, the pliers 2 are pushed down and forced to assume the lower position.

Since the engaging member 5 maintains its fixed position, the teeth 7 of the first group of teeth 7 and the additional teeth 17 also stay in their fixed position. Since the bague 100c is pushed down, all the teeth 7, 17 penetrate in the bague 100c from the lower surface of the bague 100c.

The capping step is performed by screwing the concave closure on the mouth 100d of the container 100 while the container 100 is prevented from rotating by means of the handling device 1.

In particular, since the teeth 7, 17 engage with the bague 100c, the rotation of the container 100 under the action of the screwing torque applied to the concave closure is prevented.

At the end of the capping step, the capping head 201 is rised in the resting position, and thus the pliers 2 are called back to the upper position (for example by elastic means).

The capped container 100 also rises while supported by the pliers 2.

All the teeth 7, 17 can now disengage from the bague 100c.

Once the pliers 2 have reached the upper position, the gripping arms 21, 22 are opened so that the capped container 100 can be delivered to a transfer star-wheel arranged downstream the capping apparatus 300.

In the second embodiment of the invention, the pliers support 3 (and thus the pliers 2) are fixedly mounted on the rotating carousel 301.

The process for capping a container 100 with this second embodiment is disclosed below, with focus on a single capping station 200.

A container 100 to be capped is fed to the capping station 200.

The gripping arms 21, 22 are initially in the open configuration in such a way that the container 100 can be inserted in the capping station 200.

Once the container 100 has been inserted in the capping station 200, the gripping arms 21, 22 pass to the closed configuration so as to grip the container 100 under the bague 100c.

The bague 100c of the container 100 rest on the teeth 7 of the first group of teeth 7 and preferably on the additional tooth or teeth 17 of the handling device 1.

Initially, the capping head 201 is in the resting position, which means the capping head 201 is distanced from the mouth 100d of the container 100. The capping head 201 holds a concave closure.

Upon the capping head 201 descends on the mouth 100d of the container 100, passing from the resting position to the working position, the container 100 is pushed down.

In this second embodiment, the pliers 2 as well as the engaging member 5 maintain their fixed positions.

Since the bague 100c is pushed down, all the teeth 7, 17 penetrate in the bague 100c from the lower surface of the bague 100c.

The capping step is performed by screwing the concave closure on the mouth 100d of the container 100 while the container 100 is prevented from rotating by means of the handling device 1.

In particular, since the teeth 7, 17 engage with the bague 100c, the rotation of the container 100 under the action of the screwing torque applied to the concave closure is prevented.

At the end of the capping step, the capping head 201 is rised in the resting position.

The container 100 is not pressed down anymore, thus all the teeth 7, 17 can disengage from the bague 100c. This is done by means of a fixed sloped guide working on the external part of the neck 100b, the sloped guide raising the container from the teeth 7, 17.

The gripping arms 21, 22 may be opened so that the capped container 100 can be delivered to the transfer star-wheel.

In a variant embodiment, not shown, the capping apparatus 300 is of the linear type.

The characteristics of the handling device for handling a container in a capping station and of the capping apparatus for capping containers, according to the present invention, prove to be clearly indicated in the description provided.

In particular, the arrangement of the arcuate element of the engaging member below the gripping arms and the fitting of the teeth inside recesses obtained in the gripping arms result in a more compact assembly with respect to the prior art solutions.

The proposed handling device may be used for any kind of container format and bottom, provided the neck is the same.

In addition, the proposed handling device may be used also for containers having square or polygonal cross-section. In fact, this device does not require a predefined positioning of the container before capping.

1. A handling device (1) for handling a container (100) in a capping station (200), the container (100) having a neck (100b) with an annular protuberance or bague (100c), said handling device (1) comprising:
pliers (2) comprising two gripping arms (21, 22), each gripping arm (21, 22) having a free end (21a, 22a), the free ends (21a, 22a) of the gripping arms (21, 22) being shaped so as to mutually cooperate in gripping the neck (100b) of the container (100) under the bague (100c);
a pliers support (3) for supporting the pliers (2), each gripping arm (21, 22) being hinged to the pliers support (3);
an engaging member (5) comprising an arcuate element (6) with at least one first group of teeth (7) protruding from the arcuate element (6), said arcuate element (6) delimiting a pocket (8) for receiving the neck (100b) of the container (100), said arcuate element (6) being arranged below the gripping arms (21, 22) and the teeth (7) of the first group of teeth (7) being arranged within passages or recesses (9) obtained in the free ends (21a, 22a) of the gripping arms (21, 22).

2. The handling device (1) according to claim 1, wherein in the free end (21a, 22a) of each gripping arm (21, 22) is obtained at least one recess (9) configured to receive at least one tooth (7) of the first group of teeth (7).

3. The handling device (1) according to claim 1, wherein said arcuate element (6) comprises at least one additional tooth (17) protruding from the arcuate element (6), said at least one additional tooth (17) being arranged within a gap (4) obtained between said gripping arms (21, 22).

4. The handling device (1) according to claim 3, wherein the teeth (7) of the first group of teeth (7) and said at least one additional tooth (17) are distributed along the arcuate element (6) so as to surround the pocket (8).

5. The handling device (1) according to claim 4, wherein said additional tooth (17) and the teeth (7) of the first group of teeth (17) are uniformly distributed along the arcuate element (6).

6. The handling device (1) according to claim 3, wherein said at least one additional tooth (17) is identical to the teeth (7) of the first group of teeth (7).

7. The handling device (1) according to claim 1, wherein said gripping arms (21, 22) are rotatable with respect to the pliers support (3) at least between:
a closed configuration, in which the free ends (21a, 22a) of the gripping arms (21, 22) are brought close in order to grip the container (100) under the bague (100c), and
an open configuration, in which the free ends (21a, 22a) of the gripping arms (21, 22) are moved away to each other in order to release the container (100) or to receive a new container (100).

8. The handling device (1) according to claim 1, wherein the teeth (7) of the first group of teeth (7) are higher than said recesses (9), said engaging member (5) being configurable at least in a first configuration in which the teeth (7) of the first group of teeth (7) are in contact with the lower surface of the bague (100c) of the container (100), and in a second configuration in which the teeth (7) of the second group of teeth (7) enter the bague (100c) from the lower surface.

9. The handling device (1) according to claim 1, wherein the teeth (7) of the first group of teeth (7) are shorter than said recesses (9), said engaging member 5 being configurable at least in a first configuration in which the teeth (7) of the first group of teeth (7) do not contact the bague (100c) of the container (100), and in a second configuration in which the teeth (7) of the first group of teeth (7) enter the bague (100c) from a lower surface of the bague (100c).

10. The handling device (1) according to claim 1, wherein the gripping arms (21, 22) are hinged to the pliers support (3) at two distinct hinge axes (A-A, B-B).

11. The handling device (1) according to claim 1, further comprising a holding member (10) to which said engaging member (5) is fixedly mounted.

12. A capping apparatus (300) for capping containers (100), said capping apparatus (300) comprising a rotating carousel (301) and a plurality of capping stations (200) arranged on the rotating carousel (301), each capping station (200) in turn comprising:
a capping head (201) configurable at least in a resting position in which the capping head (201) is distanced from a mouth (100d) of a container (100) arranged in the corresponding capping station (200), and a working position in which the capping head (201) presses a concave closure onto the mouth (100d) of the container (100) arranged in the corresponding capping station (200);
a handling device (1) according to claim 1, said handling device (1) being integrally mounted on the rotating carousel (301).

13. The capping apparatus (300) according to claim 12, wherein the pliers (2) and the pliers support (3) of each handling device (1) are swivelly mounted on the rotating carousel (301) so as to assume at least an upper position and a lower position, the pliers (2) being forced to pass from the upper position to the lower position in response to the capping head (201) assuming the working position.

14. The capping apparatus (300) according to claim 12, wherein the pliers (2) and the pliers support (3) of each handling device (1) are fixedly mounted on the rotating carousel (301).

15. A process for capping containers (100) using the capping apparatus (300) of claim 14, said process comprising for each capping station (200) the following steps:
configuring the capping head (201) in the resting position, the capping head (201) holding a concave closure;
transferring one of the containers (100) to the corresponding handling device (1);
configuring the pliers (2) in the upper position with respect to the rotating carousel

(301) ;
configuring the gripping arms (21, 22) in an open configuration in which the free ends (21a, 22a) of the gripping arms (21, 22) are moved away to each other in order to receive the container (100);
once the container (100) has been inserted in the capping station (200), moving the gripping arms (21, 22) to a closed configuration in which the free ends (21a, 22a) of the gripping arms (21, 22) are brought close in order to grip the container (100) under the bague (100c);
resting the bague (100c) on the gripping arms (21, 22);
lowering the capping head (201) with the concave closure towards the mouth (100d) of the container (100) so as to assume the working position;
upon exerting a pressure by the capping head (201) on the mouth (100d) of the container (100), forcing the pliers (2) to assume the lower position with respect to the rotating carousel (301) and allowing the teeth (7) of the first group of teeth (7) to penetrate in the bague (100c);
screwing the concave closure on the mouth (100d) of the container (100) while preventing the container (100) from rotating by means of the handling device (1);
raising the capping head (201) so that it assumes the resting position;
calling the pliers (2) back to the upper position;
disengaging the teeth (7) of the first group of teeth (7) from the bague (100c);
configuring the gripping arms (21, 22) in the opening configuration so that the capped container (100) can be delivered.

16. A process for capping containers (100) using the capping apparatus (300) of claim 14, said process comprising for each capping station (200) the following steps:
configuring the capping head (201) in the resting position, the capping head (201) holding a concave closure;
transferring one of the containers (100) to the corresponding handling device (1);
configuring the gripping arms (21, 22) in an open configuration in which the free ends (21a, 22a) of the gripping arms (21, 22) are moved away to each other in order to receive the container (100);
once the container (100) has been inserted in the capping station (200), moving the gripping arms (21, 22) to a closed configuration in which the free ends (21a, 22a) of the gripping arms (21, 22) are brought close in order to grip the container (100) under the bague (100c);
resting the bague (100c) on the teeth (7) of the first group of teeth (7)
lowering the capping head (201) with the concave closure towards the mouth (100d) of the container (100) so as to assume the working position;
upon exerting a pressure by the capping head (201) on the mouth (100d) of the container (100), forcing the bague (100c) to lower so as to allow the teeth (7) of the first group of teeth (7) to penetrate in the bague (100c);
screwing the concave closure on the mouth (100d) of the container (100) while preventing the container (100) from rotating by means of the handling device (1);
rising the capping head (201) so that it assumes the resting position;
disengaging the teeth (7) of the first group of teeth (7) from the bague (100c);
configuring the gripping arms (21, 22) in the opening configuration so that the capped container (100) can be delivered.
